(19) United States
(12) Patent Application Publication
(10) Pub. No.: US 2019/0325764 A1
(43) Pub. Date: Oct. 24, 2019

(54) AIRPORT MONITORING SYSTEM

(71) Applicant: Fugro Technology B.V., Leidschendam (NL)

(72) Inventors: Johannes Maria SINGER, Leidschendam (NL); Devrez Mehmet KARABACAK, Leidschendam (NL)

(73) Assignee: Fugro Technology B.V., Leidschendam (NL)

(21) Appl. No.: 16/467,803

(22) PCT Filed: Dec. 7, 2017
(86) PCT No.: PCT/NL2017/050821

§ 371 Date: Jun. 7, 2019

(30) Foreign Application Priority Data
Dec. 8, 2016 (NL) 2017957

(51) Int. Cl. G08G 5/06; G08G 5/00; G01L 1/24

(52) U.S. Cl. CPC G08G 5/065; G01L 1/242; G08G 5/0082

(57) ABSTRACT

The airport monitoring system (1) for monitoring an airport territory (5), comprises an airport territory surface and an optic sensor system (70, 72a, . . . , 72e, 100). The airport territory surface has a traffic infrastructure to support conveyance elements of a vehicle (90), e.g. an aircraft or a service vehicle, therewith allowing movements of the vehicle over the airport territory surface.

The optic sensor system (70, 72a, . . . , 72e, 100), includes an interrogator module (100) and fiber optic sensors (72a, . . . , 72e) coupled thereto. The fiber optic sensors are arranged below the airport territory surface and have a respective plurality of optic strain-sensor elements (722) with mutually different optical characteristics.

The interrogator module (100) transmits optical interrogation signals into the fiber optic sensors and receives respective response optical signals that have been modulated by the fiber optic sensors based on their optical characteristics. The interrogator module (100) identifies changes in the optical characteristics of the received respective response optical signals resulting from strains induced in the optic strain-sensor elements as a result of pressure exerted by a conveyance element (92) of a vehicle (90) on the airport territory surface (51) near a fiber optic sensor.

### BACKGROUND

Traffic at the airport runways continues to increase due to a growing demand for air travel. This results in a tightly scheduled ground traffic in the airports involving a wide range of aircraft as well as ground support vehicles. Furthermore, airports are ever expanding such that many crisscrossing grid of runways and taxi lanes are formed over a large area often designed around many terminal buildings. Additionally, the terminal buildings are increasingly being designed to have form factors resembling Christmas tree layouts with multiple branches in between which aircraft is parked or approached for boarding and fueling needs. This results in a complex layout of the airport paths making ground traffic monitoring difficult to monitor and visualize.

In the recent years, while air accident rates have been steadily reducing, ground collisions or near-miss incidents involving aircraft in airports has increased significantly. Incursions, defined as occurrence of the incorrect presence of an aircraft, vehicle, or person on the protected area of a surface designated for the landing or take-off of aircraft, is one leading source of collisions or near-miss events. Several deadly accidents involving aircraft collisions have been reported in the past decade, sometimes resulting in explosions of the aircraft with many casualties.

In response to the issue of incursions, an increasing effort in signaling and ground radar deployment has been undertaken in many airports. However, the ground radar systems are known to have significant challenges; they are known to be prone to being effected by weather conditions, can result in errors in identifying vehicles both as false positive and false negative especially due to the large variations in size of the vehicles on the ground (from double decker planes to support cars), and are expensive units with short measurement range. Most importantly however, they need a clear line of sight to make measurements resulting in many “dark spots” with no measurements in the ever expanding airports with complex layouts involving Christmas tree/branching type configuration of buildings and ground ways.

As such, there exists a need precise measurement technique which can cover large areas and form grids, be immune to weather conditions including lightening risks, and able to identify vehicle type and size, its traveling direction and speed.

### SUMMARY OF THE INVENTION

It is an object of the present invention to provide an improved airport monitoring system that addresses at least one of those needs.

In accordance therewith an airport monitoring system is provided as claimed in claim 1. In summary, the improved airport monitoring system comprises an airport territory surface and an optic sensor system. The airport territory surface has a traffic infrastructure to support conveyance elements of a vehicle, e.g. an aircraft or a service vehicle, therewith allowing movements of the vehicle over the airport territory surface. The optic sensor system includes an interrogator module and fiber optic sensors coupled thereto. The fiber optic sensors are arranged below the airport territory surface and have a respective plurality of optic strain-sensor elements with mutually different optical characteristics.

The interrogator module transmits optical interrogation signals into the fiber optic sensors and receives respective response optical signals that have been modulated by the fiber optic sensors based on their optical characteristics. The interrogator module identifies changes in the optical characteristics of the received respective response optical signals resulting from strains induced in the optic strain-sensor elements as a result of pressure exerted by a conveyance element of a vehicle on the airport territory surface near a fiber optic sensor.

The fiber optic sensors being arranged below the airport territory surface are well protected against external influences and require only a modest amount of cabling. The optic sensor system renders it possible to monitor various relevant conditions. The optic sensor system can for example be used to track traffic movements, monitor intrusion, monitor occupancy of parking lots and the like as is described in more detail with reference to the drawings.

Preferably, at least one of the fiber optic sensors extends at least substantially according to a straight line in a direction at least substantially parallel to the airport territory surface. A fiber optic sensor is considered to extend substantially according to a straight line if at least its portion embedded in the infrastructure nowhere has a radius of curvature less than 5 m. Preferably the radius of curvature is nowhere less than 20 m. As the at least one fiber optic sensor extends at least substantially according to a straight line optical losses therein are extremely low, and the lifetime of the fiber optic is increased, thereby mitigating maintenance and recalibration requirements. In some embodiments, an external portion of the optic fiber, i.e. extending outside the traffic infrastructure may have a smaller radius of curvature, for example to facilitate connection with other elements. An external portion can be replaced more easily than an internal portion, i.e. embedded in the traffic infrastructure so that a modest risk of failure may be acceptable. A fiber optic sensor may be considered to extend at least substantially parallel to the traffic carrying surface if its distance to a plane defined by the traffic carrying surface does not vary by more than 30%. In other words a depth of a fiber optic sensor may vary between D−0.15*D and D+0.15*D, wherein D is the average value of the depth. Preferably the depth variations are even less than 20% or more preferably less than 10%.

### BRIEF DESCRIPTION OF THE DRAWINGS

These and other aspects are described in more detail with reference to the following drawings. Therein:

FIGS. 1, 1A and 1B schematically show an airport monitoring system for monitoring an airport territory, therein FIG. 1A is a cross-section according to IA-IA in FIG. 1 and FIG. 1B is a cross-section according to IB-IB in FIG. 1;

FIG. 2 shows in more detail an example of a fiber optic sensor;

FIG. 2A shows in more detail another example of a fiber optic sensor;

FIG. 3 shows an exemplary reflection spectrum of a fiber optic sensor in a neutral, unstrained state;

FIG. 4 shows an example of an airport territory;

FIG. 5 shows an exemplary implementation of an airport monitoring system according to the present invention in the airport territory FIG. 4;

FIG. 6 shows a further exemplary implementation of an airport monitoring system according to the present invention in the airport territory FIG. 4;

FIG. 7 shows a still further exemplary implementation of an airport monitoring system according to the present invention in the airport territory FIG. 4;

FIG. 8 schematically shows an arrangement of a signal processing module and an interrogator coupled to a set of optic fibers;

FIG. 9 shows an exemplary embodiment of a signal processing unit in the signal processing module;

FIG. 10 schematically shows an alternative arrangement of a signal processing module and an interrogator coupled to a set of optic fibers;

FIG. 11 shows a further embodiment, wherein the airport monitoring system further comprises a motion identification module to determine motion characteristics of vehicles within said airport territory;

FIGS. 12a, 12b, 12c, schematically illustrate various signals to be processed by an interrogator unit, that are obtained from a fiber optic sensor; therein FIG. 12a indicates a single signal pattern from an optic strain-sensor element; FIG. 12b shows two subsequent signal patterns; and FIG. 12c schematically shows the response received from all optic strain-sensor elements in a fiber optic sensor;

FIG. 13 shows a further embodiment wherein a runway is provided with a set of fiber optic sensors that each are coupled with a respective optic fiber to a respective interrogator unit;

FIG. 14a to FIG. 14e shows deduced signal patterns derived from signals originating in each fiber optic sensor in the set of fiber optic sensors;

FIG. 15 shows elements of a variant of the embodiment of FIG. 13;

FIG. 16 shows a still further embodiment wherein various types of monitoring modules are combined.

### DESCRIPTION OF EMBODIMENTS

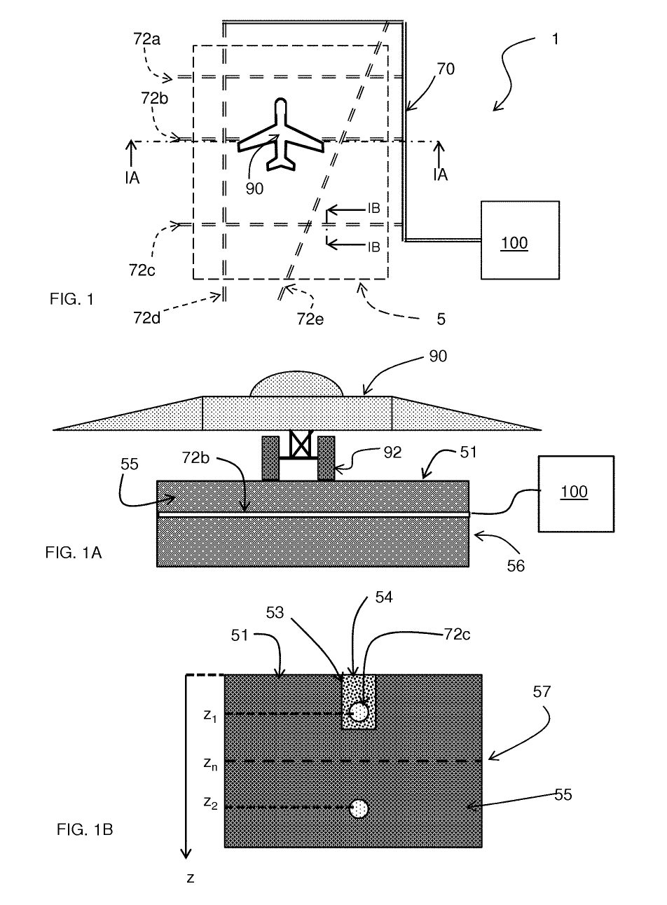

FIGS. 1, 1A and 1B schematically show an airport monitoring system 1 for monitoring an airport territory 5. Therein FIG. 1A is a cross-section according to IA-IA in FIG. 1 and FIG. 1B is a cross-section according to IB-IB in FIG. 1. The airport monitoring system comprises an airport territory surface 51 as schematically shown in FIG. 1A that has a traffic infrastructure to support conveyance elements 92 of a vehicle 90. Therewith it allows movements of the vehicle 90 over the airport territory surface 51. In the example shown the vehicle 90 is an aircraft and the conveyance elements 92 are the wheels of its landing gear. Other types of vehicles may be service vehicles, such as fueling vehicles, passenger transport vehicles or cargo transport vehicles. Other examples of conveyance elements are caterpillar tracks or runners of a sleigh. In some cases train like vehicles may be used having train wheels as their conveyance elements and being supported by rails in the airport territory surface. The airport territory surface 51 may typically include surfaces of hardened zones formed by asphalt or concrete and unhardened surfaces. In the example of FIG. 1, 1A, the surface shown is a surface of a hardened zone, for example formed by a layer 55 of asphalt or concrete. The hardened zone is typically used as a runway, a parking zones, a boarding zones, a loading zone or a parking zone.

The airport monitoring system further comprises an optic sensor system. The optic sensor system includes an interrogator module 100 and a set of one, two or more fiber optic sensors 72a, . . . , 72e that are coupled to the interrogator module and that are arranged below said airport territory surface, as schematically shown for a sensor 72b in FIG. 1A. In the embodiment of FIG. 1A, the sensor 72b is arranged between an upper hardened layer 55 and a lower hardened layer 56. This arrangement can be obtained for example during construction of the hardened zones. In that case the sensors can be arranged as an intermediate step between a step of applying the lower hardened layer 56 and the upper hardened layer 55. Alternatively, as illustrated in FIG. 1B, a fiber optic sensor 72c may be embedded in hardened layer 55 in a later stage by forming a slit 53 in the hardened layer, arranging the fiber optic sensor 72c therein and filling the slit, for example with bitumen 54. The embodiment wherein a fiber optic sensor is fully embedded between a pair of hardened layers or within a single hardened layer is advantageous as the fiber optic sensor is therewith well protected against external hazards, such as extreme stress and weather conditions. Their embedding in a hardened surface further allows a reliable and accurate measurement of various parameters, such as displacements of vehicles and properties thereof, e.g. a size or a weight. In some embodiments also fiber optic sensors may be applied in unhardened zones, such as green areas. Although this does not allow for measurements as accurate as those for hardened zones, such embodiments may still be very suitable for detection of access violations.

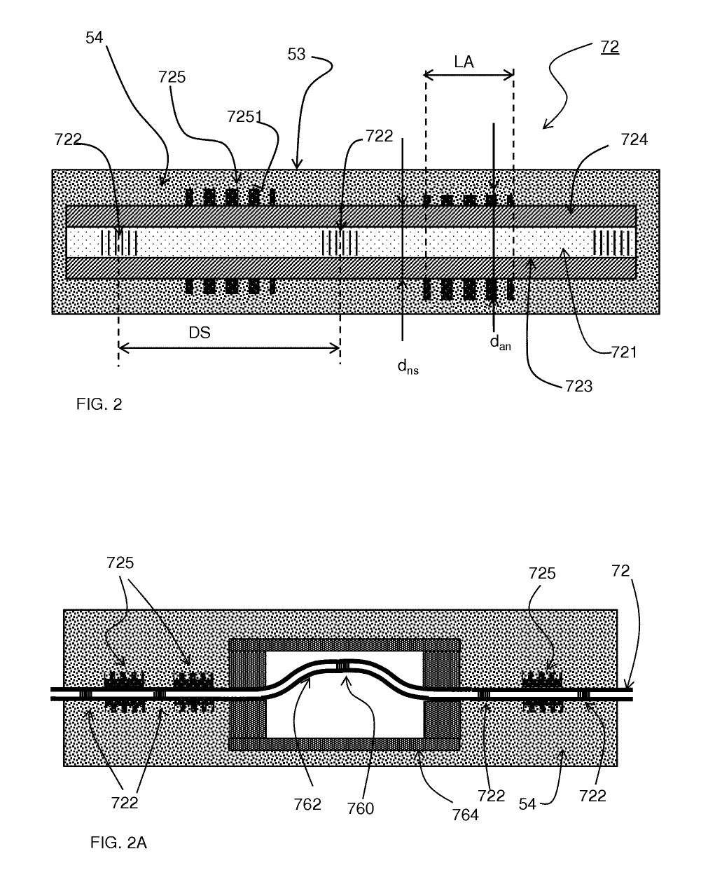

An example of a fiber optic sensor is shown in more detail in FIG. 2. As shown therein, optic fiber sensor has an optic having a respective plurality of optic strain-sensor elements 722 with mutually different optical characteristics. In particular the plurality of optic strain-sensor elements 722 have mutually different optic characteristics in that they have mutually different unconstrained reflection peaks or mutually different unconstrained absorption peaks. The wording “unconstrained” is used here as meaning the condition wherein a strain-sensor elements 722 is free from mechanical stress. The interrogator 100 is configured to transmit an optical interrogation signal of a variable wavelength into the at least one fiber optic sensor, to receive a response optical signal that has been modulated by the fiber optic sensor based on its optical characteristics, and to identify changes in the optical characteristics of the response optical signal resulting from strains induced in the optic strain-sensor elements as a result of a conveyance element 92 of a vehicle moving over the traffic carrying surface 51 across the at least one fiber optic sensor. In the embodiment shown, the optic strain-sensor elements 722 for example are fiber bragg gratings (FBG). However, also other optic strain sensitive elements are applicable, such as for example fiber lasers, interferometers formed using (non-strained) FBGs or using alternative methods. By way of example, a fiber optic sensor e.g. 72 as shown in FIG. 2 may have 30 fiber optic sensor elements spaced at regular intervals of 10 cm.

As schematically illustrated in FIG. 1B, a traffic infrastructure, such as a runway, an access road or a parking typically has a neutral axis 57. At the depth of the neutral axis traversing traffic substantially causes no strain in a direction transverse to the longitudinal direction of the infrastructure. The fiber optic sensor e.g. 72c should be arranged at a depth z₁, z₂ that is sufficiently spaced from a depth zₙ of that neutral axis 57. The depth zₙ of the neutral axis 57 may vary from case to case, and its precise depth value may be estimated using a model calculation or may be measured. Depending on the materials used for the traffic infrastructure, the neutral axis may for example be at a depth in the range of 5 to 20 cm with respect to the traffic carrying surface 51. If the fiber optic sensor 72 is arranged at a depth z₁ over the depth zₙ of the neutral axis 57, the depth z₁ is preferably greater that 2 cm, preferably greater than 5 cm. This is advantageous, in that during maintenance of the road, the upper surface can be removed without damaging the fiber optic sensor 72. If the fiber optic sensor 72c is arranged below the neutral axis 72, the depth z2 is preferably not too great as the spatial resolution of the measurements can gradually decrease with depth. Good results may for example be obtained if a fiber optic sensor 72c below the neutral axis 57 is arranged at a depth of 1.5 to 2 or 3 times zₙ.

It should be noted that sensors above and below the neutral axis 57 are not exclusive to one another, therefore, good results can also be achieved by implementing a series of sensors over the neutral axis 57 and/or another series of sensors below the neutral axis 57.

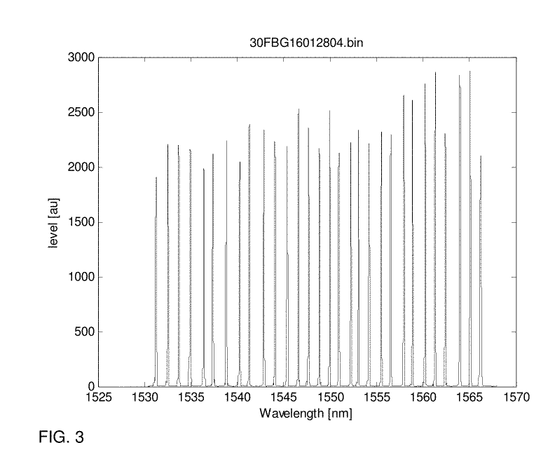

FIG. 3 shows an exemplary reflection spectrum of one of the fiber optic sensors in a neutral, unstrained state. Each of the optic strain-sensor elements 722 in the fiber optic sensor 72 has a respective narrow reflection peak. The spectral spacing of these peaks in this example is about 1.2 nm. Occurrence of strain resulting from a vehicle present on the airport territory, for example moving across an optic strain-sensor element or being parked near an optic strain sensor element causes a shift of a peak wavelength (characteristic wavelength) of that sensor element that can be detected by the interrogator 100. By way of example the interrogator 100 may have a measurement range of 40 nanometers with a recording speed of 1000 Hz and a wavelength tracking resolution of approximately 0.1 picometers.

Referring again to FIG. 2, it can be seen that the fiber optic sensor 72 is provided with at least one anchor element 725 that extends around the at least one fiber optic sensor between mutually subsequent optic strain-sensor elements 722. The at least one anchor element 725 has a circumference in a plane transverse to a longitudinal direction of the fiber optic sensor 72 that is at least 1.5 times larger than a circumference of the fiber optic sensor in a plane transverse to said longitudinal direction at a position of an optic strain-sensor element. The circumference of an anchor element may for example be in a range of 5 to 30 times a circumference of the fiber optic sensor. The at least one anchor element 725 provides for a strong longitudinal coupling of the at least one fiber optic sensor 72 with the medium wherein it is embedded, such as a layer of asphalt 55 or a filler material 54. In the embodiment shown an anchor element is provided between each pair of subsequent optic strain-sensor elements 722. The anchor elements 725 may have a length LA in the range of 0.1 to 0.7 times a distance DS between mutually subsequent optic strain-sensor elements 722. In the example shown mutually subsequent optic strain-sensor elements 722 are spaced at a distance DS of 5 to 20 cm and the anchor elements 725 between them have a length LA of a few cm, for example 2 to 5 cm. In this way a relatively high sensitivity is preserved in the optic strain-sensor elements 722, while providing a strong anchoring and coupling to the medium wherein it is embedded. A still improved anchoring of the fiber optic sensor 72 is obtained in that the anchor elements 725 are provided with tangentially extending grooves 7251.

In the embodiment shown, the fiber optic sensor 72 has a non-slip coating 724 that surrounds the optic fiber 721. The non-slip coating 724, which determines the outer surface of the fiber optic sensor between the anchor elements has a diameter dₙₛ in the range 1-3 mm. The anchor elements may have a diameter dₐₙ in the range of 5-15 mm. The non-slip coating even further improves a mechanical contact with the medium 54 wherein the optic fiber is embedded. The non-slip coating 724 in addition reinforces the optic fiber, while preserving a high resolution with which mechanic deformations can be detected. Good results can be achieved with a non-slip coating having an outer diameter in the range of 2 to 20 times an outer diameter of the optic fiber 721. By way of example the fiber optic sensor 72 may have an optic fiber with a diameter of about 0.15 mm that is provided with a non-slip coating having an outer diameter of about 1-3 mm. In the embodiment shown in FIG. 2 the non-slip coating 724 is made of a glass-fiber reinforced polymer (GFRP). An intermediate layer 723 (e.g. of a polyimide), can be arranged between the optic fiber 721 and the non-slip coating 724 for a better adherence between the latter two elements and for protection of the glass-fiber during production processes.

As a result of pressure exerted by a conveyance element of a vehicle 90 on the airport territory surface 51 near a fiber optic sensor strains are induced in one or more optic strain-sensor elements of that fiber optic sensor change. As a result the optical characteristics of these strain-sensor elements change, and these changes are identified by the interrogator module 100.

The identified changes in the optical characteristics of these optic strain-sensor elements are signaled by the interrogator module 100 and can be further processed to monitor various events and conditions.

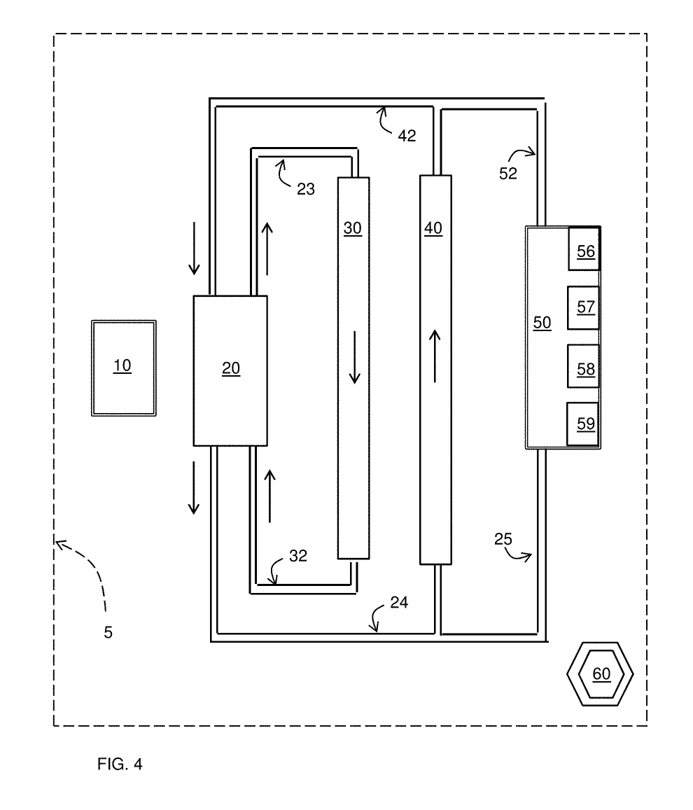

FIG. 4 shows an exemplary airport territory 5 wherein an airport monitoring system is applicable. As shown in FIG. 4, the airport territory 5 may for example include an entrance hall 10, a boarding/deboarding area 20, one or more runways 30, 40, a shed 50 and a control tower 60. Furthermore taxiways 23, 24, 25, 32, 42, 52 are provided to facilitate displacements of aircrafts and other vehicles, such as service vehicles between various locations. These may be arranged as one-way connections as shown in the drawing, or as two way connections. Also railway connections (not shown) may be provided, for example for facilitating transport of cargo by train to and on the airport territory 5.

In the embodiment shown, the shed 50 has parking locations 56, 57, 58, 59, for example to park aircrafts for fueling and maintenance purposes. Also parking locations may be provided on the boarding/deboarding area 20. Likewise a separate parking location may be provided for cargo loading.

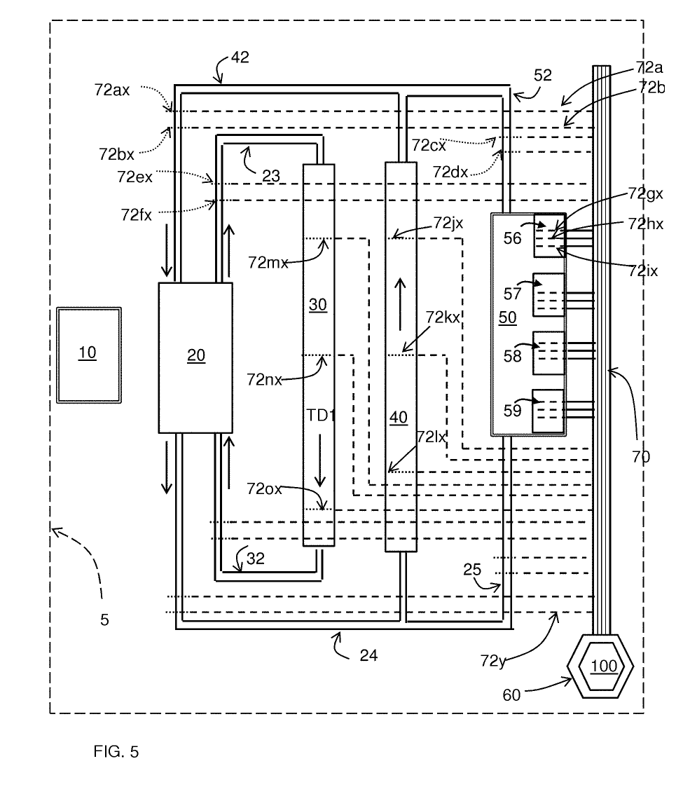

FIG. 5 shows an exemplary implementation of an airport monitoring system according to the present invention in the airport territory 5 of FIG. 4. In this implementation the optic sensor system includes a plurality of fiber optic sensors of 72ax, 72bx, . . . , 72yx that are coupled to one end of a respective optic fiber 72a, 72b, . . . , 72y. At their other end these optic fibers 72a, 72b, . . . , 72y are arranged in a fiber bundle 70 that extends to the interrogator module 100, which in this example is arranged in the housing of the control tower 60. The fiber optic sensors 72ax, 72bx, . . . , 72yx each include a respective plurality of optic strain-sensor elements. The fiber optic sensors 72ax, 72bx, . . . , 72yx may for example be provided according to the embodiment of the fiber optic sensor 72 shown in FIG. 2.

In the embodiment shown in FIG. 5, the fiber optic sensors 72ax, 72bx, . . . , 72yx are arranged below various zones 20, 30, 40, 56-59 in said airport territory surface and paths 23, 24, 25, 32, 42, 52 connecting these zones. The optic fibers 72a, 72b, . . . , 72y to which they are connected will typically also be arranged below the airport territory surface. Alternatively, the optic fibers 72a, 72b, . . . , 72y may be arranged above the airport territory surface. In the embodiment shown, each of the zones is provided with a plurality of fiber optic sensors. For example the runway 30 is provided with fiber optic sensors 72mx, 72nx, 72ox. In the embodiment shown, the fiber optic sensors 72mx, 72nx, 72ox are arranged in a mutually parallel fashion, transverse to a longitudinal axis of the runway and are spaced relative to each other along the longitudinal axis. In this case the runway has a prescribed traffic direction TD1 according to one direction of the longitudinal axis. Likewise, the runway 40 is provided with fiber optic sensors 72jx, 72kx, 72lx. Also connection paths between the various zones are provided with fiber optic sensors. By way of example reference is made to fiber optic sensors 72ax, 72bx, which are arranged below the connection path 42 from the runway 40 to the boarding/deboarding zone 20. Also in this example the fiber optic sensors 72ax, 72bx are arranged in a mutually parallel fashion, transverse to a longitudinal axis of the connection path at the location where they are arranged, and are spaced relative to each other along the longitudinal axis. As a further example fiber optic sensors 72gx, 72hx, 72ix are mentioned, which are arranged below a zone 56 of the airport surface intended for parking vehicles, e.g. for maintenance or loading purposes. By way of example two or three fiber optic sensors are shown for monitoring each zone. In practice however another number, e.g. 1, 10 or 100 of fiber optic sensors may be used for a zone.

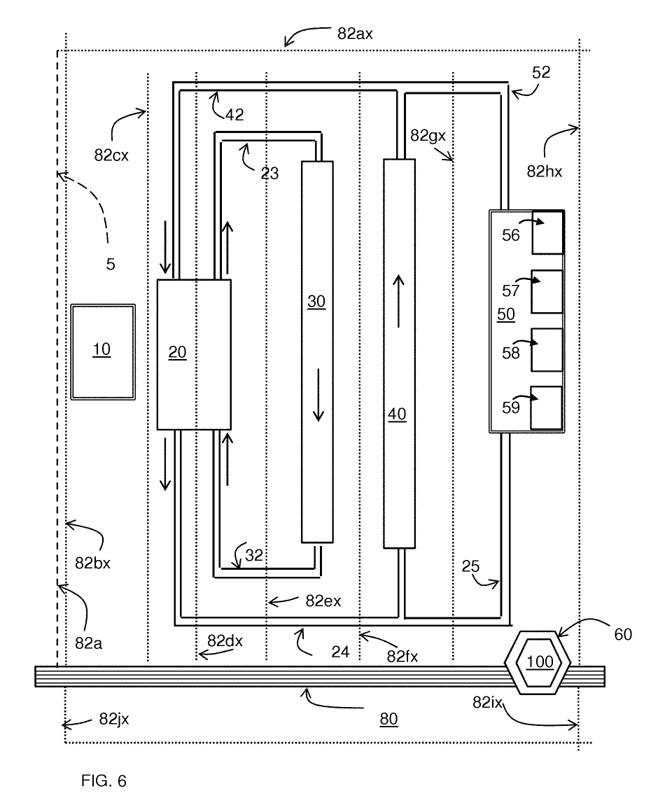

FIG. 6 shows an exemplary implementation of an airport monitoring system according to the present invention in the airport territory 5 of FIG. 4. In this implementation the optic sensor system includes a plurality of fiber optic sensors that are arranged between various zones of the airport territory 5. For example a fiber optic sensor 82cx is arranged between the entrance hall 10, and the boarding/deboarding area 20. A fiber optic sensor 82ex is arranged between the boarding/deboarding area 20 and the runway 30 and a fiber optic sensor 82fx is arranged between the runway 30 and the runway 40. Also a fiber optic sensor 82gx is arranged between the runway 40 and the shed 50. In the embodiment shown, further a fiber optic sensor 82dx is arranged along a length axis of the boarding/deboarding area 20. The set of fiber optic sensor 82cx, . . . , 82gx renders it possible to detect unauthorized movements of vehicles or persons between various zones within the airport territory. In the embodiment shown an additional set of fiber optic sensors 82ax, 82bx, 82hx, 82ix, 82jx is arranged along the periphery of the airport territory. These additional fiber optic sensors render it possible to detect unauthorized movements of vehicles or persons into the airport territory. The fiber optic sensors 82ax, . . . 82jx, are coupled via respective optic fibers 82a, . . . that are partly arranged in a bundle to the interrogator module. It is noted that an optic sensor system as shown in FIG. 5 and an optic sensor system as shown in FIG. 6 may combined.

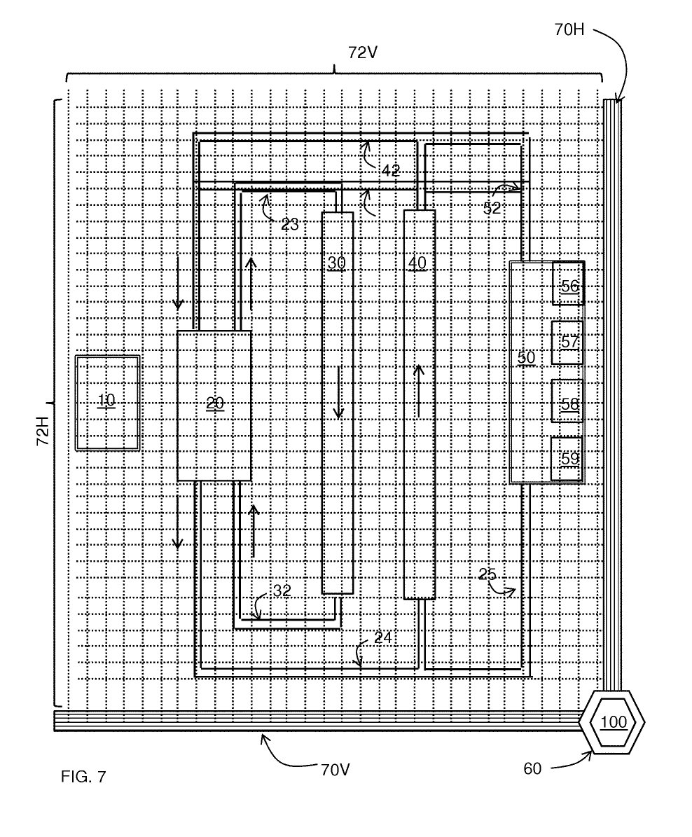

FIG. 7 shows again another embodiment. In this embodiment the optic sensor system includes a first set 72H of fiber optic sensors and a second set 72V of fiber optic sensors that are coupled via optic fiber bundles 70H, 70V to the interrogator module 100. The fiber optic sensors of the first set 72H are arranged parallel to each other and mutually spaced at a same distance. Likewise, the fiber optic sensors of the second set 72H are arranged parallel to each other and mutually spaced at a same distance. The fiber optic sensors of the first set 72H are arranged transverse to the fiber optic sensors of the second set 72V. In this way the airport territory 5 is partitioned into a grid of cells. Movements of vehicles from one to another cell as well as the speed and direction of such movements can be detected using the airport monitoring system.

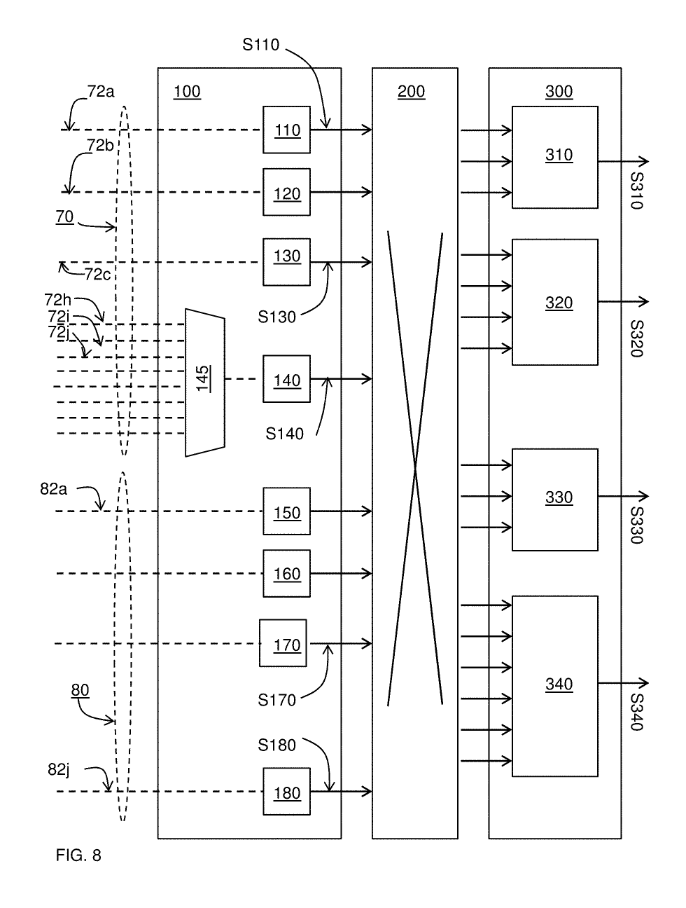

FIG. 8 schematically shows a signal processing module comprising an interrogator 100, coupled to optic fibers from optic fiber bundle 70 as shown in FIG. 5 and optic fiber bundle 80 as shown in FIG. 6. In the example shown, optic fibers 72a, 72b, 72c are coupled to a respective interrogator unit 110, 120, 130. Likewise, optic fibers 82a, . . . , 82j are coupled to a respective interrogator unit 150, . . . , 180. Optic fibers 72h, 72i, 72j, . . . are coupled via an optic multiplexer to a shared interrogator unit 140. The interrogator units, e.g. 110, generate a beam of light, of which a wavelength is swept in wavelength range. The optic strain-sensor elements of the optic sensor, e.g. 72a, coupled thereto respond in mutually different subranges of this wavelength range, so that the interrogator unit can identify the individual sensor elements and determine their individual responses to strain exerted thereon by vehicles in spatial range of the airport territory above these sensor elements. The response can typically be the reflection of a specific wavelength range of light. The center of the reflection wavelength range can change in response to strain on the strain-sensor element. Typically each optic fiber is coupled to a respective interrogator unit to enable frequent measurements with a high resolution. In many cases, high reflections can be attained from localized strain-sensor elements, as that light can be split from one wavelength swept source to multiple fibers such that multiple fiber optic sensor chains, with the reflections separately detected and analyzed, such that many more sensors can be simultaneously recorded with high precision. However, for those zones, such as parking and maintenance zones 56, 57, 58, 59, where rapid displacements are not expected, a shared interrogation unit 140 may be used which is coupled via an optic multiplexer 145 to a plurality of optic fibers 72h, 72i, 72j, . . . The optic multiplexer 145 alternately couples one of these optic fibers to their shared interrogator unit 140. The interrogator units 110, . . . , 180 generate output signals, e.g. S110, S130, S140, S170, S180, that are indicative for an amount of stress sensed by the various sensor elements of the various optic sensors at respective points in time t. The output signals of (the interrogations units of) the interrogation module 100 are provided to signal processing units 310, 320, 330, 340 of a signal processor system 300 that processes the output signals to generate monitored feature signals. In an embodiment, e.g. as shown in FIG. 8, a router 200 may be included to select specific combinations of output signals to be processed by the signal processor system 300.

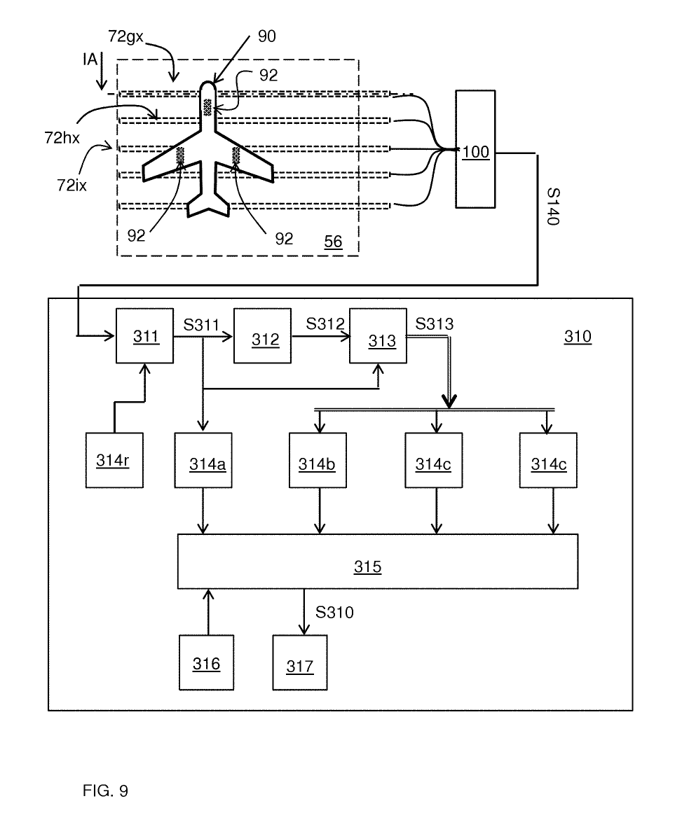

FIG. 9 shows an exemplary embodiment of the signal processing unit 310. As shown in FIG. 9 it receives the output signal S140 of the interrogation unit 100, which is representative of the strain sensed by the optic strain sensor elements of the fiber optic sensors 72gx, 72hx, 72ix, which are arranged below the parking zone 56. The signal processing unit includes an occupancy state identification module 311 that uses the output signal S140 for determining an occupancy state of a zone 56 within the airport territory 5. More in particular, the occupancy state identification module 311 includes a weight estimation unit that uses the signal S140 to generates a weight indication signal S311 that is indicative of an estimated weight of the aircraft 90, based upon the strain induced on the optic strain sensor elements by the conveyance elements 92 of the aircraft. The accuracy and reproducibility of an estimated weight may be irrelevant if the occupancy state estimation unit merely serves to indicate whether the zone 95 is occupied or not. In order to accurately and reproducibly estimate the weight, the surface of the parking zone 56 may be provided with marks that indicate the desired position of the aircraft. Alternatively a more dense arrangement of fiber optic sensors may be provided that enable an accurate and reproducible weight estimation in arbitrary positions of the aircraft 90. Apart from a weight the occupancy identification module 311 may also be configured to detect further characteristic features of a vehicle, such as a number of axes, a distance between subsequent axes and a distance between wheels on an axis.

The estimated value for the weight of the aircraft as indicated by signal S311 may be stored in a storage location 314a. An indication for a known weight of the aircraft may be stored in storage location 314r. This can be used to calibrate the weight estimation unit 311 if it appears that the estimated value of the weight as indicated by signal S311 differs significantly from the known value for the weight, as indicated by the value in storage location 314r. Alternatively or additionally an alert message may be generated upon detection of a difference between the estimated value and the known value. The estimated value of the weight may also be stored in a buffer location 312. A subtraction unit 313 is provided to subtract the value of the weight as indicated by signal S311 from a values of the weight as indicated by signal S312 at an output of the buffer location. Subtraction unit 313 provides the result as signal S313. In this way the relative weight contribution of passengers, cargo and fuel can be determined and stored in respective storage locations 314b, 314c, 314d. For example the estimated weight as indicated by signal S312 that was stored in storage location 312 before passenger boarding may be subtracted from the estimated weight as indicated by signal S311 upon completion of passenger boarding. Similarly fueling level of the vehicle can be determined by weight change during the fueling event, with the information regarding the amount of fuel loaded relayed to both control system and/or the pilot(s). The information can be extracted or obtained and/or confirmed by extracting the weight change of recording both the vehicle being loaded with fuel and/or the vehicle loading the fuel, both of which can be individually recorded by the fiber optic system in the fueling area.

In the embodiment shown, the airport monitoring system further comprises a scheduling module 316. The scheduling module provides for a scheduled occupancy state map, that specifies a scheduled occupancy state for said zone for respective timeslots.

A comparison module 315 is provided to compare an occupancy state of the zone 56 as indicated by the occupancy state identification module 311 with a scheduled occupancy state for said zone 56 as specified in the scheduled occupancy state map.

An alert module 317 is provided to issue an alert message if the comparison module 315 detects that an occupancy state of a zone 56 as indicated by the occupancy state identification module 311 differs from the scheduled occupancy state for that zone. The alert module 317 may for example issue the alert message if the comparison module 315 detects that the zone 56 is occupied, whereas the scheduling module indicates that the zone is free. If the occupancy state identification module 311 is configured to estimate a weight of a parked vehicle and the scheduling module 316 has specified a weight that differs from that estimation then the alert module 317 may likewise issue an alert message.

In the embodiment shown in FIG. 9, module 315 also serves as a fueling verification module. In operation it provides a fueling recommendation based on a flight schedule, and weight of said aircraft in a loaded state as determined by the weight estimation unit of the occupancy state identification module 311.

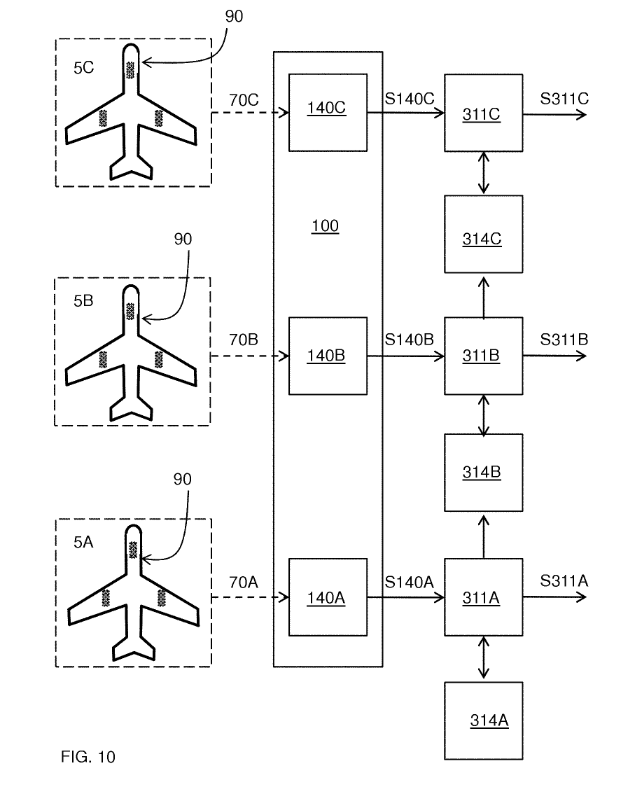

In practice an aircraft 90 may be fueled, loaded and boarded in subsequently different zones 5A, 5B, 5C, as schematically indicated in FIG. 10. Each of these zones has respective fiber optic sensors coupled by respective connections 70A, 70B, 70C for providing the optic signals to be used by the interrogator module 100. Also different interrogator units 140A, 140B, 140C within the interrogator module 140 may be involved that provide a respective output signal S140A, S140B, S140C to respective intrinsic weight calibration units as schematically indicated in FIG. 10.

As in the embodiment of FIG. 10, the airport monitoring system comprises an intrinsic weight calibration unit 314A, that is configured to calibrate the occupancy state identification module 311A based on an empty weight of the aircraft 90 according to its specifications.

The embodiment of FIG. 10 comprises a further occupancy state identification modules 311B and a loaded state weight calibration unit 314B. The loaded state weight calibration unit 314B uses a weight as determined by the occupancy state identification module 311A to calibrate the further occupancy state identification module 311B. To that end the loaded state weight calibration unit 314B receives from occupancy state identification module 311A a first input signal indicative for a weight of the aircraft 90 after it is fueled before it is transported to zone 5B and receives from occupancy state identification module 311B a second input signal indicative for a weight of the aircraft 90 after it is transported to zone 5B, before further actions have taken place. The weight calibration unit 314B compares these signals to calibrate the occupancy state identification module 311B. Subsequently the aircraft 90 is loaded in zone 5B and upon completion its weight is measured again by occupancy state identification module 311B. Similarly, a still further occupancy state identification modules 311C and a loaded state weight calibration unit 314C is provided. The loaded state weight calibration unit 314C receives from occupancy state identification module 311B a first input signal indicative for a weight of the aircraft 90 after it is loaded, but before it is transported to zone 5C and receives from occupancy state identification module 311C a second input signal indicative for a weight of the aircraft 90 after it is transported to zone 5C, before further actions have taken place. The weight calibration unit 314C compares these signals to calibrate the occupancy state identification module 311C. Subsequently passengers can board the aircraft 90 in zone 5C. The events described above can be in different measurement zones or can be in the same measurement zone happening in different measurement time segments.

It is noted that the calibration units 314A, 314B, 314C may use various comparisons to determine a proper calibration of the respective occupancy state identification modules 311A, 311B, 311C. From various comparisons performed for aircrafts with mutually different weights it may for example become apparent that a weight estimation of an occupancy state identification modules 311A is too high for a first weight range and is too low for a second weight range.

The estimated value for the weight by each of the occupancy state identification modules is represented by output signals S111A, S111B and S111C.

In order to compensate for the detected deviations the weight West as indicated by the estimated weight signal may be corrected as Wcorr by the following relation:

Wcorr=a*West+Wb

Wherein “a” is a multiplication factor and Wb is a constant.

Also a more complex relation may be used to calculate the corrected estimated weight value.

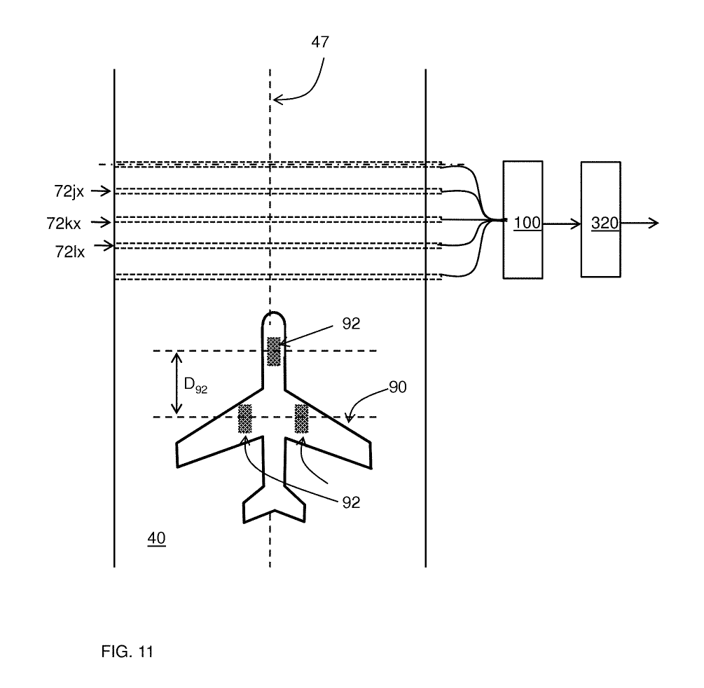

FIG. 11 shows a further embodiment, wherein the airport monitoring system further comprises a motion identification module 320 to determine motion characteristics of vehicles within said airport territory. In the embodiment shown the motion identification module 320 is provided to identify motions on runway 40. To that end the runway 40 is provided with fiber optic sensors 72jx, 72kx, 72lx that are arranged in a mutually parallel fashion, distanced from each other, and transverse to a longitudinal axis 47 of the runway. Upon exertion of a pressure on the runway 40 by the tires 92 of the landing gear, one or more strain sensor elements of the fiber optic sensor 72j for example, change their characteristic frequency λₘₐₓ as schematically indicated for a strain sensor element in FIG. 12a. The magnitude Δλₘₐₓ of the change in its characteristic frequency is substantially proportional to the amount of strain induced on that strain sensor element. Upon traversal of a conveyance element 92 of the aircraft 90 across a strain sensor element an optic signal pattern can be detected as shown in FIG. 12a.

FIG. 12b shows a superposition of signal patterns resulting from the traversal of the front tire of the aircraft over a strain sensor element of the fiber optic sensor 72j at point in time t1, and the traversal of the back tires of the aircraft over other strain sensor elements of the fiber optic sensor 72j at point in time t2.

The instantaneous speed vₛ of the aircraft 90 can be estimated by

Vs=D₉₂/(t2−t1), wherein D₉₂ is the distance between the front wheel and the back wheels of the aircraft 90 as indicated in FIG. 11 Alternatively, the instantaneous speed vs of the aircraft 90 can be estimated by

Vs=D₇₂/(tj−tk), wherein D₇₂ is the distance between the fiber optic sensors 72jx and 72kx and wherein tj is the point in time where a wheel 92 of the aircraft is detected by a strain sensor element of fiber optic sensor 72jx and tk is the point in time where the same wheel 92 is detected by a strain sensor element of fiber optic sensor 72kx. In this configuration, once the vehicle speed Vs is identified, the vehicle axel length, or the distance between the vehicle wheels, can be extracted by D₉₂=Vs*(t₂−t₁), where in t₁ and t₂ are the time delays between the measured events on one fiber optic measurement line. The axel length of the vehicle, along with its weight and wheel load characteristics, can be used for its identification and/or identity confirmation, and to track its movement by comparing its identity information to signatures obtained in different locations of the airport field.

A proper ascending or descending of the aircraft 90 can further be determined from an amount of strain induces in the sensor element of the fiber optic sensors at various points in time during its departure or arrival on the runway. Also the ratio of strain induced by the front wheel and by the back wheels of the aircraft can indicate if the arrival or departure proceeds properly. Deviations from normal behavior may be signaled to enable the pilot to correct the arrival or departure procedure.

FIG. 12c schematically shows the responses of all optic strain-sensor elements in a fiber optic sensor during traversal of the aircraft 90. Therein the vertical axis (x) indicates the position in the longitudinal direction of the fiber optic sensor and the horizontal axis indicates the point in time. The response of the sensors is schematically illustrated by a hatching. A dark hatching indicates an increase of the peak wavelength and a light hatching indicates a decrease of the peak wavelength or negligible change. In the illustration of FIG. 12c the optic strain-sensor elements arranged around position x_{mid} show an increase of their peak wavelength in a time-interval centered around t1, due to the front wheel (or pair or set of front wheels closely arranged near each other) traversing the runway above the fiber optic sensor wherein they are arranged. In the same time interval the optic strain-sensor elements arranged aside, e.g. around x_{left} and x_{right} show a decrease of their peak wavelength due to a compressive stress, albeit at lower amplitude. At point in time t2, optic strain-sensor elements laterally arranged at positions xleft′ and xright′ with respect to the trajectory followed by the aircraft, show an increase of their peak wave length, while the optic strain-sensor elements further to the right and further to the left, as well as the optic strain-sensor elements in the center show a decrease of their wavelength.

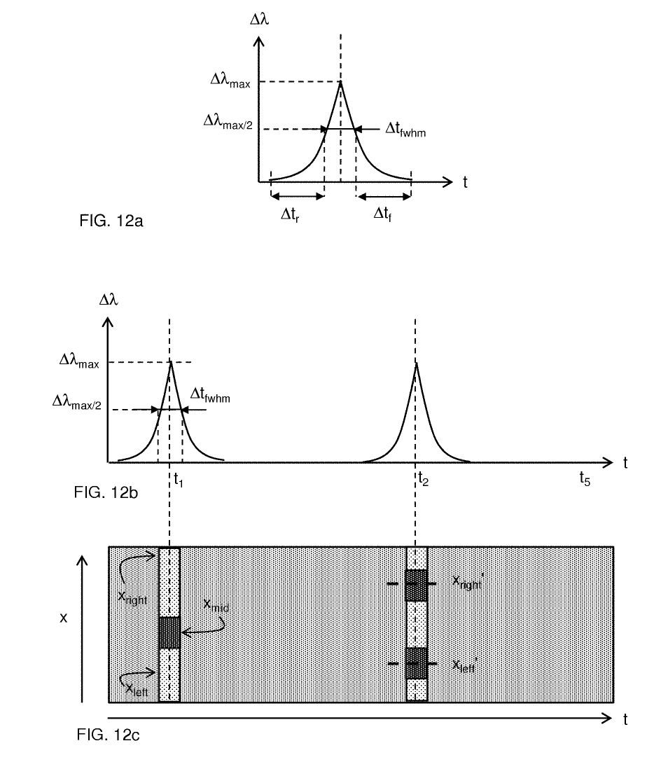

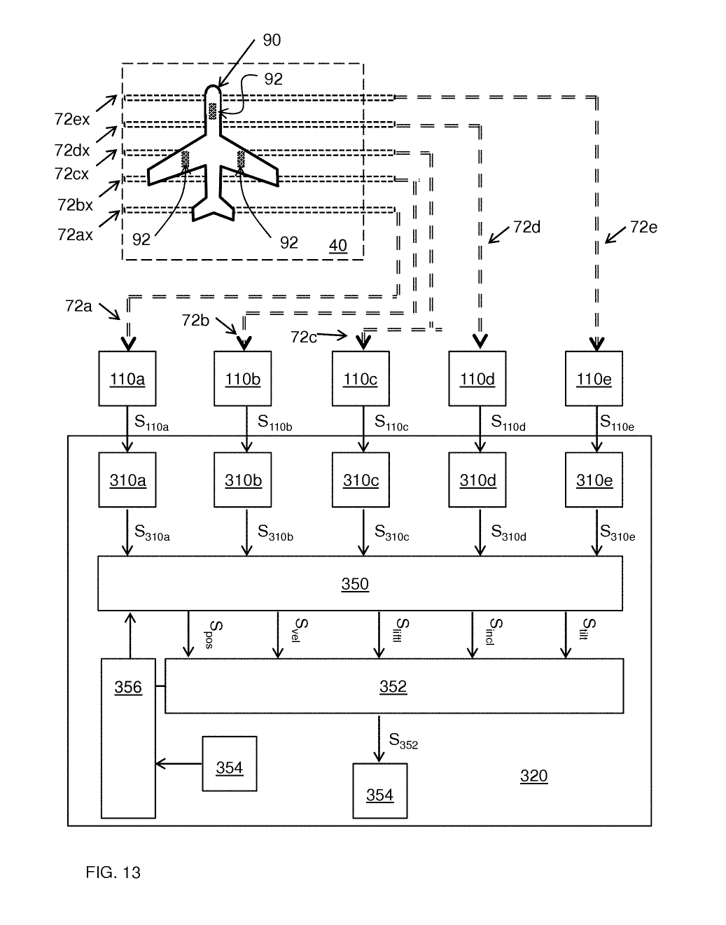

FIG. 13 shows a further embodiment wherein the runway 40 is provided with a set of fiber optic sensors 72ax, . . . , 72ex, that each are coupled with a respective optic fiber to 72a, . . . , 72e, to a respective interrogator unit 110a, . . . , 110e. The interrogator units 110a, . . . , 110e each generate an output signal S₁₁₀ₐ, . . . , S₁₁₀ₑ indicative for an amount of strain sensed by the optic strain-sensor elements of the fiber optic sensor 72ax, . . . , 72ex to which they are connected. The motion identification module 320 processes these output signal S₁₁₀ₐ, . . . , S₁₁₀ₑ. In the embodiment of FIG. 13, a proper signal pattern analysis unit 310a, . . . , 310e is provided for each of the interrogator units 110a, . . . , 110e. The signal pattern analysis units 310a, . . . , 310e analyze the signal they receive from their associated respective interrogator unit 110a, . . . , 110e, to generate an output signal S₃₁₀ₐ, . . . , S₃₁₀ₑ indicative for an estimated force or pressure exerted by the individual wheels 92 of the aircraft 90. Alternatively, or in addition the output signals of the signal pattern analysis units 310a, . . . , 310e, may be indicative for a state of the aircraft when it moves over the runway. For example the output signals may indicate a lift of the aircraft which can be estimated from the total amount of force or pressure exerted by the aircraft's wheels 92. Also the output signals may indicate an inclination of the aircraft 90 which can be estimated from a ratio between the force or pressure exerted by the front wheels of the aircraft 90 and its back wheels. Still further the output signals may indicate a tilt of the aircraft 90 which can be estimated from a ratio between the force or pressure exerted by the back wheels of the aircraft 90 on its left side and its right side. The motion identification module 320 further includes a signal pattern correlating unit 350. The latter correlates the output signals S₃₁₀ₐ, . . . , S₃₁₀ₑ of the signal pattern analysis units 310a, . . . , 310e to provide a single signal for each parameter to be monitored. For example the signal pattern correlating unit 350 generates an output signal Sₚₒₛ for indicating a current position, a signal Sᵥₑₗ for indicating a current velocity, a signal S_{lift} for indicating an estimated lift, a signal S_{incl} for indicating and estimated inclination, and a signal Sₜᵢₗₜ for indicating an estimated tilt. The signal pattern correlating unit 350 can relatively easily correlate a signal pattern of a signal S110a of a signal pattern analysis units 310a with that of another signal pattern analysis units e.g. 310b. For example by taking into account the lateral position of the optic strain-sensor elements of a fiber optic sensor that cause the original signal. The parts of the signal originating from the same lateral positions should be correlated. Alternatively, or in addition the correlation may be based on the order in which the patterns occur in time.

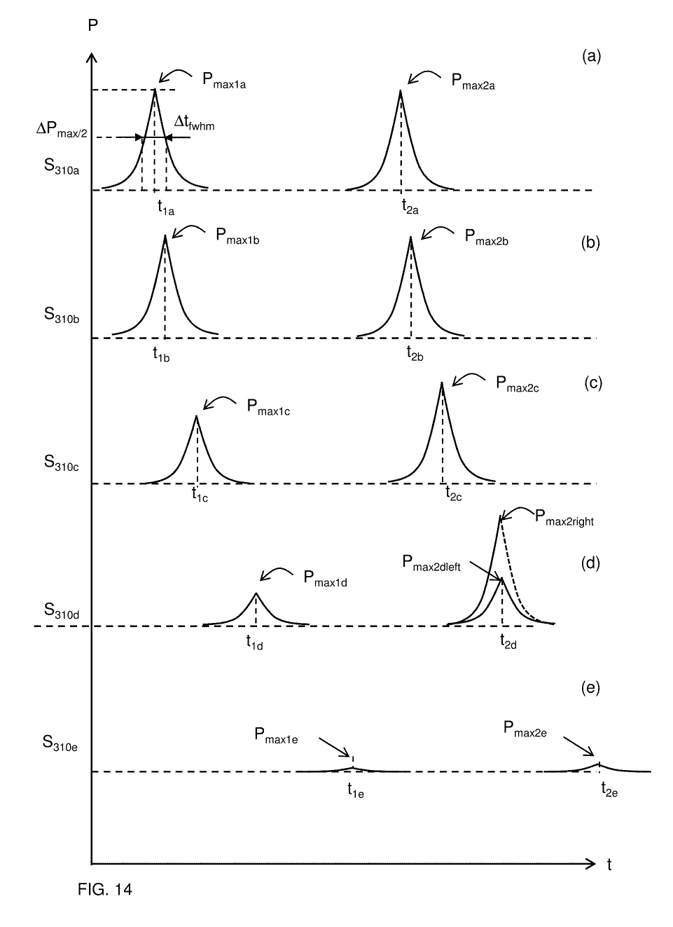

This is illustrated in FIG. 14a to FIG. 14e. FIG. 14a to FIG. 14e schematically shows the estimated pressure P, as indicated by the signals S₃₁₀ₐ, . . . , S₃₁₀ₑ as which are estimated by the signal pattern analysis units 310a, . . . , 310e on the basis of interrogator output signals S110a, . . . , S110e, obtained by the interrogator units 110a, . . . , 110e from their associated fiber optic sensors 72a, . . . , 72e.

FIG. 14a show a first peak Pₘₐₓ₁ₐ at point in time t₁ₐ and a second peak at Pₘₐₓ₂ₐ at point in time tea from the first fiber optic sensor 72a respectively caused by the front wheel(s) and the back wheels of the aircraft 90. The signal correlating unit 350 can correlate these peaks with a first peak P_{max1b} at point in time t_{1b} and a second peak at P_{max2b} at point in time t_{2b} from the second fiber optic sensor 72b, due to the correspondence of time order of peaks Pₘₐₓ₁ₐ, Pₘₐₓ₂ₐ and peaks P_{max1b}, P_{max2b}. Likewise the signal correlating unit 350 can correlate the signals S₃₁₀e, . . . , S₃₁₀e provided by the other signal pattern analysis units 310c, . . . , 310e with each other, and with the signals S₃₁₀ₐ, S_{310b}.

As indicated above, the signal processing units 310a, . . . , 310e, may estimate state information of the aircraft 90, such as a lift, an inclination or a tilt of the aircraft. Alternatively, the signal correlating unit 350 may estimate said state information using the signals S310a, . . . , S310e from the signal pattern analysis unit 310a, . . . , 310e. In the signal correlating unit 350 the current position of the aircraft can be estimated from the position of the fiber optic sensor from which the most recent signals were received. The signal correlating unit may indicate this as a signal Sₚₒₛ. The signal correlating unit 350 may estimate a velocity from the lapse of time between the detection of a peak in the signal originating from one of the fiber optic sensors and a neighboring fiber optic sensor. The signal correlating unit 350 may indicate the estimated velocity with a signal Sᵥₑₗ. The signal correlating unit 350 may use the estimated velocity to improve the estimation of the current position of the aircraft 90. The signal correlating unit 350 may indicate an estimated amount of lift by a signal S_{lift}. The signal correlating unit 350 may base the estimation on the estimated total amount of pressure as estimated by the signal processing units 310a, . . . , 310e. In the signal correlating unit 350 it can for example be detected that the amount of pressure as estimated on the basis of the signals originating from fiber optic sensor 310d is substantially less than the amount of pressure as estimated on the basis of the signals originating from a fiber optic sensor. This indicates that the aircraft already experiences already a substantial amount of lift when it traverses fiber optic sensor 310d. The signal correlating unit 350 may further estimate an amount of inclination and indicate this as a signal S_{incl}. For example in the signal correlating unit 350 it can be detected that the ratio P_{max1c}/P_{max2c} is less than the ratio P_{max1b}/P_{max2b}. This indicates that the front wheels of the aircraft are already being released from the surface. Still further the signal correlating unit 350 may estimate an amount of tilt and indicate this as a signal Sₜᵢₗₜ. By way of example FIG. 14d shows an example wherein the estimated pressure P_{max2left} on the left side of the aircraft is substantially smaller that the estimated pressure P_{max2right} on the right side of the aircraft 90. The ratio between the estimated pressure P_{max2left}/P_{max2right} is an indication of the tilt of the aircraft. Alternatively this information may be further processed to provide the indication in terms of an estimated tilt angle.

Returning to FIG. 13, it can be seen that a verification unit 352 is included in the motion identification module 320. The verification unit 352 receives one or more signals Sₚₒₛ, Sᵥₑₗ, S_{lift}, S_{incl}, Sₜᵢₗₜ indicative for a state of the aircraft 90 and issues a state verification signal S₃₅₂. The verification unit 352 may be coupled to an alert unit 354 to generate an alert message if the state as indicated by these one or more signals does not comply with an expected state. The alert unit may issue the alert message and optional recommendations for correction to the air-traffic controller and/or directly to the aircraft's pilot.

The motion identification module 320 further includes a scheduling unit 356. The scheduling unit providing for a scheduled motion list, that specifies a scheduled set of motion characteristics within said airport territory. The information provided in the scheduled motion list may be used by verification unit 352 to verify if the observed state complies with an expected state. This information may also be used by pattern correlating unit 350 to more accurately estimate certain state information.

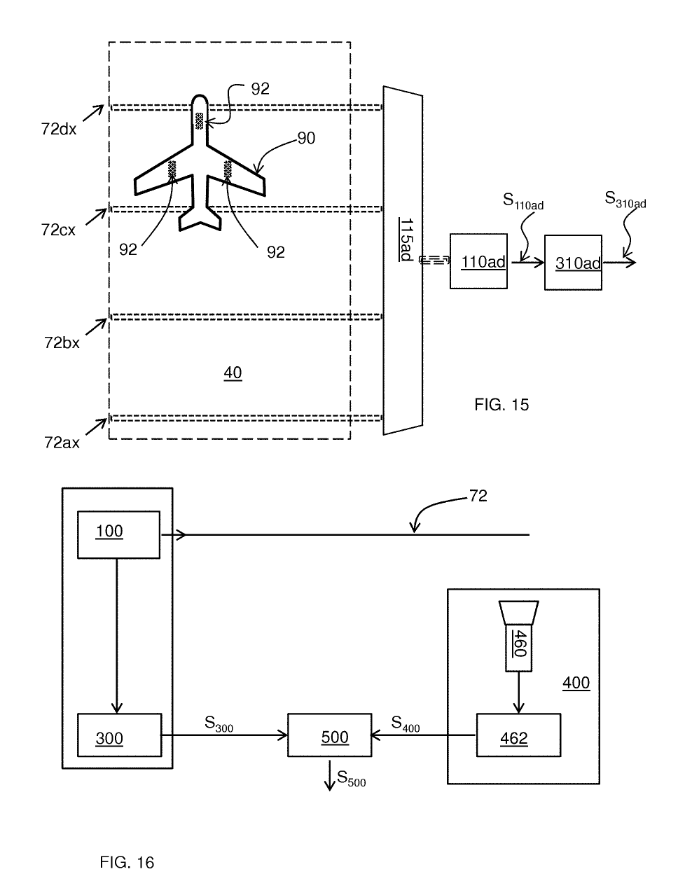

FIG. 15 shows part of an alternative of the embodiment of FIG. 13. In the embodiment shown fiber optic sensors 72ax, . . . , 72dx are arranged at relatively large distance from each other. I.e. their mutual distance is larger than a distance between a front axis and a rear axis of aircrafts 90 that are expected to use the runway 40. In the embodiment shown the fiber optic sensors 72ax, . . . , 72dx are coupled via an optic multiplexer 115ad to an interrogator unit 110ad. In this case a single interrogator unit 110ad is sufficient to interrogate the fiber optic sensors 72ax, . . . , 72dx and a single signal processor 310ad suffices to process the output signals S110ad of the interrogator unit 110ad and to provide its output signal S310AD. The optic multiplexer 115ad may for example by default couple the first fiber optic sensor 72ax to the single interrogator unit 110ad, and each time couple a subsequent fiber optic sensor 72bx, 72cx, 72dx to the single interrogator unit 110ad once it has received a complete signal pattern from a fiber optic sensor 72ax, 72bx, 72cx.

The airport monitoring system may include further monitoring modules as is for example schematically indicated in FIG. 16. Therein a combination of an interrogator module 100 and signal processor system 300 is combined with a further monitoring module 400 including a camera 460 and an image processing system 462. Output signals S₃₀₀ and S₄₀₀ from the interrogator/signal processor module and the further monitoring module are correlated with each other and provided as integrated output signal S₅₀₀ by combination unit 500, and signals from one sub-unit can be used to trigger recordings in other units, e.g. detection of motion from the fiber optic system can be triggered to capture an image of the vehicle and/or its identification plate.

The various modules and units for preforming the signal processing tasks as described above, may be provided as dedicated hardware, as generally programmable devices having a dedicated simulation program, as dedicated programmable hardware having a dedicated simulation program, or combinations thereof. Also configurable devices may be used, such as FPGA's. Also various combinations of such computational resources may be used. The various computational resources may be integrated in a single processing system, but alternatively, the computational resources by be geographical spread, exchange data with each other via wired or wireless connections. It is also conceivable that a remote server is provided to perform all computations and that a client is installed at the airport territory to transmit raw or preprocessed data to the remote server and to receive processed output data from the remote server.

Additionally, the fiber optic strain sensing chains can be used in determining the impact of the individual events or their cumulative effects on the runways or other infrastructures in the airport area. Statistical analysis of deformations can be used in determining the total number of deformation cycles experienced by portions or segments of the runway, helping plan maintenance and repair operations. Furthermore, the strain sensing elements will also record strains induced by deformations of the infrastructure over long time scale. For that, the strain values can be recorded during time periods in which vehicles are not present to map the longitudinal and lateral deformation of the runways. The same recording system is used as above, with longer time segment, e.g. minutes long, recording of the wavelengths is averaged to provide static information. In preferred embodiment, the recordings are multiple times during the day.

In a further embodiment, for example as illustrated in FIG. 2A, fiber optic sensor elements are embedded into the runway which are substantially insensitive to strain but substantially sensitive to temperature. In the embodiment of FIG. 2A this is achieved by encapsulating the fiber optic sensor element 760 in a housing 764 in a substantially mechanically decoupled manner. I.e. in the encapsulated fiber optic sensor is arranged in the housing in a manner that mitigates effects of deformations of the runway on strains occurring in the fiber optic sensor element 760. This can be achieved for example in that the fiber optic sensor element 760 is maintained in a substantially unstrained configuration. In the embodiment shown, this is achieved in that a longitudinal section 762 of the fiber optic sensor 72 is arranged in a loose and slightly curved manner inside the housing 764, therewith ensuring that longitudinal strains are not substantially coupled to the fiber optic sensing element. The fiber optic sensor element 760 may be fixed to the housing at its ends. The thermally induced effects are dominantly governing the wavelength response characteristics of the sensing element 760. Preferably the housing 764 is of a thermally good conducting material, for example a metal such as copper or steel so that a temperature inside the housing rapidly follows the temperature prevailing in the runway 54. It is not necessary that the fiber optic sensor element 760 is kept in a substantially unstrained configuration inside the housing, as long as a strain in the fiber optic sensor element 760 is substantially not influenced by deformations or strains of the runway. This can also be achieved in that the fiber optic sensor element 760 is kept at a substantially constant strain within the housing. The wording “substantially”, as used in “substantially mechanically decoupled”, “substantially unstrained configuration” and “substantially constant strain” is used to indicated that any remaining influences of mechanical deformation of the runway on the fiber optic sensor element 760 do not substantially disturb temperature measurements. For example mechanical deformations of or strains in the runway occurring during normal use thereof do not cause deviations in temperature measurements exceeding 0.5 degrees, or preferably not exceeding 0.1 degrees, or most preferably not exceeding 0.05 degrees, or even not exceeding 0.01 degrees.

As illustrated in FIG. 2A, the fiber optic sensor elements, such as element 760 can be of the same type as those used for sensing strain. A longitudinal portion of the fiber optic sensor 72 as shown in FIG. 2A, respectively comprises two fiber optic sensor elements 722 arranged for sensing strain, the fiber optic sensor element 760 arranged for sensing temperature and two fiber optic sensor elements 722 arranged for sensing strain. The fiber optic sensor elements 722, 722, 760, 722, 722 have mutually exclusive reflection wavelength range values that allow them to be identified. By having several temperature measurement locations in different positions on the airport field, the ground conditions can be better monitored. By directly measuring the temperature of segments of the runway, potential risk points for, for example, icing or wetness can be determined and necessary alerts generated. In a further embodiment, heating systems that can also be embedded in the runways, can be adjusted and activated, either locally or globally, on the different segments of the infrastructure to mitigate icing or wetness to improve surface conditions for aircraft and vehicles.

In a further embodiment, measurement data obtained with the temperature sensing elements 760 can be used to correct for deviations in the response of the strain sensing elements.

1. An airport monitoring system for monitoring an airport territory, the airport monitoring system comprising:
an optic sensor system; including an interrogator module, and one or more fiber optic sensors coupled to the interrogator module and arranged below an airport territory surface, the one or more fiber optic sensors comprising a respective optic fiber, the optic fiber having a plurality of optic strain-sensor elements with mutually different optical characteristics,
wherein, the interrogator module is configured to transmit respective optical interrogation signals into the one or more fiber optic sensors, to receive respective response optical signals that have been modulated by the one or more fiber optic sensors based on their optical characteristics, and to identify changes in the optical characteristics of the received respective response optical signals resulting from strains induced in the plurality of optic strain-sensor elements as a result of pressure exerted by a conveyance element of a vehicle on the airport territory surface.

2. The airport monitoring system according to claim 1, wherein the one or more fiber optic sensors extend at least substantially according to a straight line in a direction at least substantially parallel to the airport territory surface.

3. (canceled)

4. The airport monitoring system according to claim 1, further comprising:
at least one mechanically decoupled optic sensor element below an airport territory surface that is mechanically decoupled from a traffic infrastructure, wherein the interrogator module is configured to determine a temperature based on response optical signals obtained from the at least one mechanically decoupled optic sensor element.

5.-7. (canceled)

8. The airport monitoring system according to claim 4, wherein the interrogator module is configured to apply temperature compensation in analysis of response optical signals obtained from the plurality of optic strain-sensor elements in accordance with a temperature as estimated on the basis of the response optical signals obtained from the at least one mechanically decoupled optic sensor element.

9. The airport monitoring system according to claim 4, wherein the interrogator module is configured to verify operation of a heating system arranged below the airport territory surface.

10. The airport monitoring system according to claim 4, wherein the at least one mechanically decoupled optic sensor element is formed in a fiber optic sensor of the one or more fiber optic sensors that additionally comprises the plurality of optic strain-sensor elements.

11. The airport monitoring system according to claim 4, wherein the at least one mechanically decoupled optic sensor element and the plurality of optic strain-sensor elements in a fiber optic sensor of the one or more fiber optic sensors are of the same type.

12.-15. (canceled)

16. The airport monitoring system according to claim 1, wherein an optic fiber of the one or more fiber optic sensors is provided with a non-slip coating.

17. (canceled)

18. The airport monitoring system according to claim 16, further comprising an intermediate layer arranged between the optic fiber and the non-slip coating.

19. (canceled)

20. The airport monitoring system according to claim 1, further comprising an occupancy state identification module configured to determine an occupancy state of a zone within airport territory.

21. The airport monitoring system according to claim 20, further comprising a scheduling module, the scheduling module configured to provide a scheduled occupancy state map configured to specify a scheduled occupancy state for zone.

22. (canceled)

23. (canceled)

24. The airport monitoring system according to claim 20, wherein the occupancy state identification module is configured to identify one or more characteristics of a vehicle that occupies the zone, and wherein the occupancy state indicates the identified characteristics.

25. The airport monitoring system according to claim 24, wherein the one or more characteristics include a weight of the vehicle.

26. The airport monitoring system according to claim 25, wherein the vehicle is an aircraft, and wherein the airport monitoring system includes a fueling verification module configured to provide a fueling recommendation based on a flight schedule, and weight of the aircraft in a loaded state as determined by the airport monitoring system.

27. The airport monitoring system according to claim 25, comprising at least an intrinsic weight calibration unit, wherein the intrinsic weight calibration is configured to calibrate the occupancy state identification module based on an empty weight of the aircraft.

28. (canceled)

29. The airport monitoring system according to claim 1, further comprising a motion identification module for determining motion characteristics of vehicles within the airport territory.

30. The airport monitoring system according to claim 29, further comprising a scheduling module, the scheduling module providing for a scheduled motion list, that specifies a scheduled set of motion characteristics within the airport territory.

31. (canceled)

32. (canceled)

33. The airport monitoring system according to claim 28, wherein the motion characteristics include at least one of a speed and a direction.

34. The airport monitoring system according to claim 29, wherein the motion characteristics include at least one of an inclination and a lift.

35. (canceled)

36. (canceled)

37. The airport monitoring system according to claim 1, comprising an access authorization control module to monitor vehicles accessing the airport territory, and configured to indicate whether the accessing complies with predetermined authorization.

38. (canceled)
